(19) United States
(12) Patent Application Publication
(10) Pub. No.: US 2006/0229987 A1
(43) Pub. Date: Oct. 12, 2006

(54) Check replication detection system and method

(76) Inventor: John Thomas Leekley, Parsippany, NJ (US)

Correspondence Address: Quinn Law Group, PLLC, Suite 520, 39555 Orchard Hills Place, Novi, MI, 48375, US

(21) Appl. No.: 11/369,141

(22) Filed: Mar. 6, 2006

Related U.S. Application Data
(60) Provisional application No. 60/669,500, filed on Apr. 8, 2005.

(51) Int. Cl. G06Q 40/00

(52) U.S. Cl. 705/45; 705/42

(57) ABSTRACT

A system and method are provided whereby a clearing intermediary identifies replicated items (electronic check images, substitute checks, or original checks) that are received from one or more banks of first deposit by comparing unique identifiers, such as those found in the MICR line of the original check, and finding two or more matches. The unique identifiers may include the routing/transit number, account number, and check number, or other suitable identifiers.

### CROSS REFERENCE TO RELATED APPLICATION

This application claims the benefit of U.S. Provisional Patent Application Ser. No. 60/669,500, filed Apr. 8, 2005, and which is hereby incorporated by reference in its entirety.

### TECHNICAL FIELD

This invention relates to systems and methods for detecting checks or derivatives of original checks presented multiple times during a check clearing process.

### BACKGROUND OF THE INVENTION

Prior to October, 2004, a bank was required to present an original paper check for payment unless the paying bank had agreed to accept presentment in some other form. Sections 3-501(b)(2) and 4-110 of the Uniform Commercial Code (U.C.C.) specifically authorized banks and other persons to agree to alternative means of presentment, such as electronic presentment. However, under the U.C.C., a presenting bank would need electronic presentment agreements with each bank to which it presents checks to engage in broad-based electronic presentment. This has proven impracticable because of both the large number of paying banks and the unwillingness of some paying banks to receive electronic presentment.

The requirement that banks present the original check absent agreement to the contrary, and the difficulty of obtaining alternate presentment agreements with all paying banks, impeded the ability of banks to process checks electronically. As a result, the payment system as a whole had not achieved the efficiencies and potential cost savings associated with handling checks electronically.

The “Check Clearing for the 21^{st} Century Act,” also referred to herein as the “Check 21 ” Act, became effective on Oct. 28, 2004. The Check 21 Act is codified at 12 U.S.C. §§ 5001-5018. Implementation of the Check 21 Act is found in Title 12, Part 229 of the Code of Federal Regulations. By authorizing the use of a new negotiable instrument called a “substitute check,” the Check 21 Act facilitates the broader use of electronic check processing without mandating that any bank change its current check collection practices.

A substitute check is a paper reproduction of an original check that contains an image of the front and back of the original check, and is suitable for automated processing in the same manner as the original check. A bank that, for consideration, transfers, presents, or returns a substitute check (or a paper or electronic representation of a substitute check) warrants that (1) the substitute check contains an accurate image of the front and back of the original check and a legend stating that it is the legal equivalent of the original check, and (2) no depositary bank, drawee, drawer, or indorser will be asked to pay a check that it already has paid. A substitute check that meets the Check 21 Act's requirements, and for which a bank has made the substitute check warranties, is the legal equivalent of the original check for all purposes and all persons.

The use of legally equivalent substitute checks should facilitate the check clearing process. For example, prior to the Check 21 Act, a depositary bank in California that received a check drawn on a bank in New York was required to send the original paper check for collection unless it, or an intermediary collecting bank that presents checks sent by it, had an electronic presentment agreement with the paying bank. Under the Check 21 Act, by contrast, the California bank could transfer check information electronically to a collecting bank in New York with which it had an agreement to do so. The New York collecting bank then could create a substitute check to present to the New York paying bank. The New York paying bank would be required to take presentment of the substitute check. Thus, instead of processing and transporting the original check across the country, the California bank could collect the substitute check using only local New York transportation.

Substitute checks are therefore advantageous in that they enable banks to transmit electronic data representing a check, rather than a paper copy of the check during the clearing process. However, by relying on digitized check images instead of original documents, it is possible for a single check to be replicated and presented multiple times. Current industry processes would not detect replicated items caused by, for example, the same item being erroneously transmitted in multiple, different files or formats, such as when an electronic check image for an original check is transmitted multiple times or when multiple substitute checks are printed for one original check. Nor would the replicated item be detected if the item originated from two different parties. Check 21 makes both of these scenarios possible.

### SUMMARY OF THE INVENTION

A system for detecting duplicate checks during check processing is provided. The system includes at least one scanner sufficiently configured to scan original checks and substitute checks originating from a first plurality of entities and, for each of said original checks and substitute checks, generate a respective data set including a respective identifier.

The system also includes at least one electronic communication link in selective electronic communication with a second plurality of entities. The at least one electronic communication link is sufficiently configured to receive image replacement document data sets in electronic form, i.e., electronic check images. Each of the image replacement document data sets contains the information necessary to prepare a respective substitute check including a respective identifier.

The system further includes a storage medium storing a database of stored unique identifiers. At least one computer processor is operatively connected to the storage medium, the at least one scanner, and the at least one communication link.

The at least one computer processor is sufficiently programmed and configured to, for each data set received from the at least one scanner and the at least one electronic communication link, determine whether the respective identifier is identical to one of the stored identifiers in the database. The at least one computer processor is configured and programmed to store the respective identifier in the database if the respective identifier is not identical to one of the stored identifiers in the database. The at least one computer processor is further programmed and configured to transmit a notification signal if the respective identifier is identical to one of the stored identifiers in the database.

The system, being configured to receive original checks, substitute checks, and image replacement document data from multiple entities, improves upon the prior art by providing item replication detection at a macro level in the check clearing process, rather than merely at a bank of first deposit or paying bank, and, in some instances, by providing item replication detection early in the check clearing process. For example, it is contemplated that the system may be used or operated by a clearing intermediary. In the context of the claimed invention, a “clearing intermediary” is an entity that is involved in the clearing process of a check and that is neither the paying bank nor the bank of first deposit. More specifically, a “clearing intermediary” receives, processes, or transmits checks, substitute checks, or electronic check images, but it not a bank of first deposit or a paying bank.

A corresponding method is also provided whereby a clearing intermediary identifies replicated items. The method includes being a clearing intermediary, receiving a plurality of checks, substitute checks, and/or electronic check images from a plurality of entities. For each of the plurality of checks, substitute checks, and/or electronic check images, the method further includes capturing a respective identifier, comparing the respective identifier to stored identifiers in a database, and determining whether the respective identifier is identical to any of the stored identifiers in the database.

The method also includes notifying a third party if the respective identifier is identical to any of the stored identifiers in the database, and storing the respective identifier in the database if the respective identifier is not identical to any of the stored identifiers. Notification may be sent electronically via e-mail, SWIFT message, etc. to any of the following possible recipients: depositing party, third party processor, drawn-on bank, payee, payor or other parties involved in the clearing process.

### BRIEF DESCRIPTION OF THE DRAWINGS

FIG. 1 is a schematic depiction of a first check clearing scenario wherein a clearing intermediary receives checks, subsitute checks, and electronic check images from banks of first deposit and presents checks or substitute checks to paying banks;

FIG. 2 is a schematic depiction of a system for detecting duplicate checks;

FIG. 3 is a flow chart depiction of a method and exemplary control logic for the system of FIG. 2;

FIG. 4 is a schematic depiction of a second check clearing scenario wherein a lockbox provider receives checks and transmits checks, substitute checks, or electronic check images to another clearing intermediary, and transmits deposit data to banks of first deposit; and

FIG. 5 is a schematic depiction of a third check clearing scenario wherein an outsourcing provider receives checks, substitute checks, or electronic check images from banks of first deposit, and transmits checks, substitute checks, or electronic check images to another clearing intermediary.

### DESCRIPTION OF THE PREFERRED EMBODIMENTS

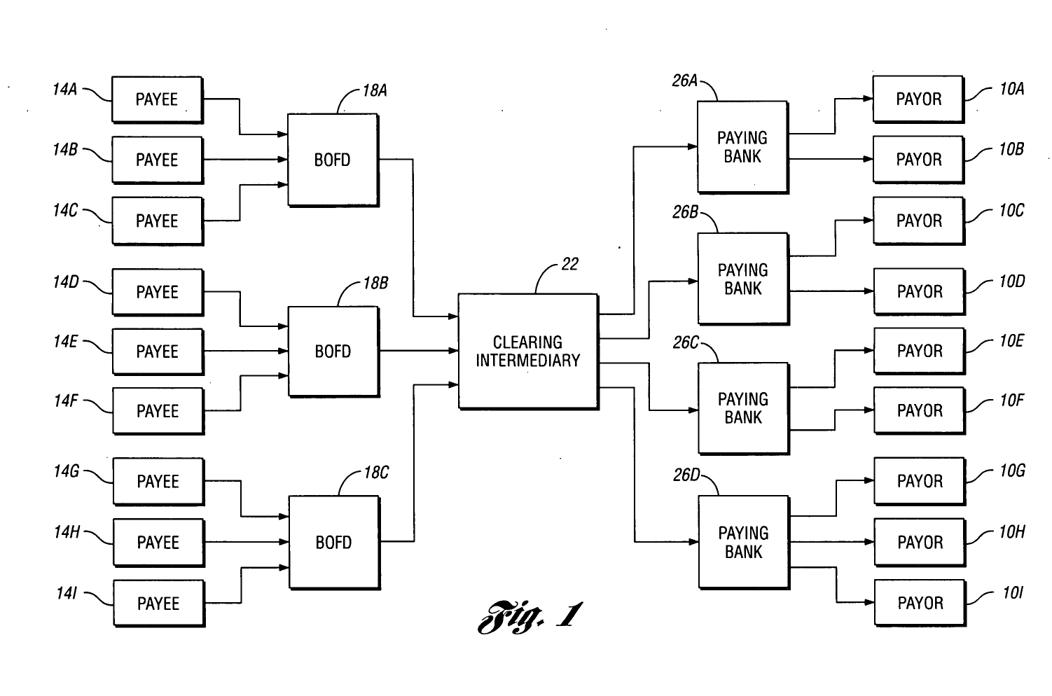

Referring to FIG. 1, a first check clearing scenario is schematically depicted. Payors 10A-10I send or present checks to payees 14A-14I as understood by those skilled in the art. The payee of each check deposits the check at a selected bank 18A-18C, i.e., a “Bank of First Deposit” (BOFD). The BOFDs 18A-18C are distinct legal entities and are separately-owned. The BOFDs may or may not be within the United States within the scope of the claimed invention. In the embodiment depicted, BOFD 18A receives checks from payees 14A-14C; BOFD 18B receives checks from payees 14D-14F; and BOFD 18C receives checks from payees 14G-14I.

Each check has a unique set of characteristics, including information contained in the magnetic ink character recognition line (commonly referred to as the “MICR line”), which represent unique identifiers for that check. The specific information/unique identifier for the check includes, but is not limited to, the routing/transit number of the drawn-on (paying) bank, the payor's account number at that bank, and the check number.

For each check received, the BOFDs transmit an item comprising one of (a) the original check; (b) an electronic image of the check, i.e., an electronic data set representing the information required to prepare a substitute check; or (c) a substitute check to a clearing intermediary 22. Advantageously, the BOFD may scan or otherwise process an original check to obtain the electronic image, and transmit the electronic image (instead of an original paper check) to the clearing intermediary. Exemplary clearing intermediaries include the Federal Reserve Bank, a correspondent bank, a check clearinghouse, etc.

The drawn-on banks 26A-26D, also referred to herein as “paying banks,” typically receive a check or a substitute check from the clearing intermediary 22 for each of the items transmitted by the BOFDs. The drawn-on banks then, under normal circumstances, debit the account of the payor of each check as understood by those skilled in the art.

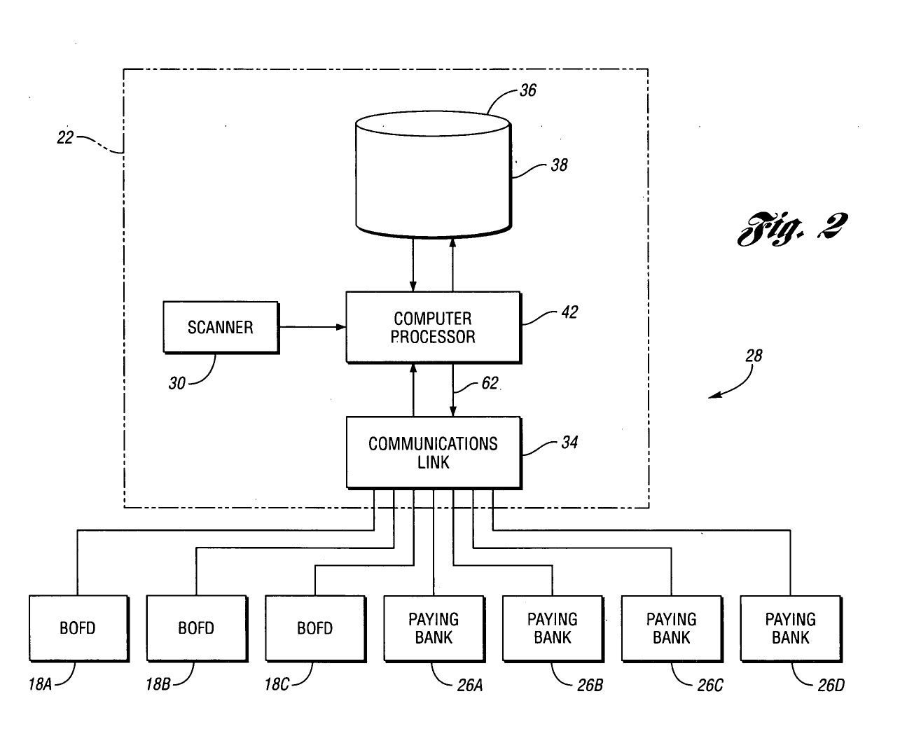

Referring to FIG. 2, wherein like reference numbers refer to like components from FIG. 1, a system 28 for detecting duplicate checks during check processing is schematically depicted. The system 28 includes at least one scanner 30 sufficiently configured to scan original checks and substitute checks originating, or received, from a first plurality of entities, i.e., BOFDs 18A-C. The system also includes at least one electronic communication link 34 in selective electronic communication with a second plurality of entities, which, in the embodiment depicted, includes BOFDs 18A-C and paying banks 26A-D. Within the scope of the claimed invention, a “first plurality of entities” and a “second plurality of entities” may or may not include common entities. Thus, for example, a first plurality of entities and a second plurality of entities may be identical, may have common entities, or may have no entities in common with one another.

The system 28 also includes a storage medium 36 storing a database 38 of stored identifiers. Within the scope of the claimed invention, a “storage medium” may or may not include multiple storage media. Thus, for example, a “storage medium storing a database” may include, within the scope of the claimed invention, several storage mediums each storing a portion of the database. The system 28 also includes at least one computer processor 42 that is operatively connected to the scanner 30 and the communication link 34 to receive data therefrom. The computer processor 42 is also operatively connected to the storage medium 36 to transmit data thereto and receive data therefrom.

The scanner 30, communications link 34, processor 42, and database storage medium 38 are depicted in FIG. 2 as being parts of, or operated by, the clearing intermediary 22. However, and within the scope of the claimed invention, the system 28 or any part thereof may be located or maintained by another entity. For example, the database storage medium may be located at and maintained by another entity besides the clearing intermediary 22, but accessed by the computer processor 42 of the clearing intermediary or the computer processors of multiple clearing intermediaries.

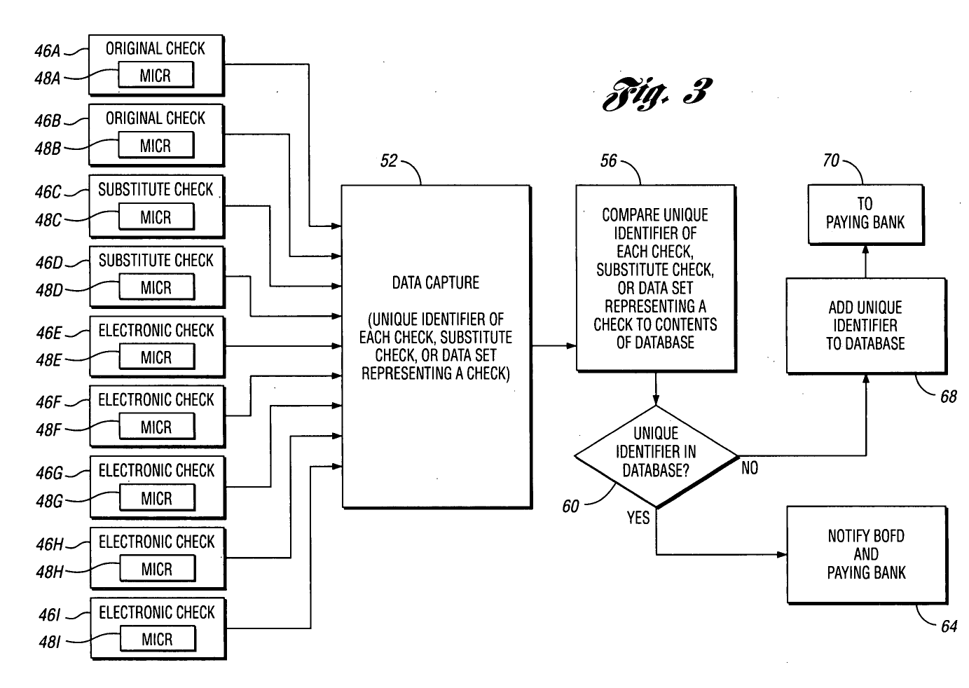

FIG. 3 is a schematic depiction of a method that may be advantageously employed by the clearing intermediary 22. FIG. 3 also represents an exemplary control logic for the system 28 of FIG. 2. Referring to FIGS. 2 and 3, the clearing intermediary 22 receives items 46A-46I from the BOFDs 18A-18C. For example, BOFD 18A may transmit items 46A-46C, BOFD 18B may transmit items 46D-46F, and BOFD 18C may transmit items 46G-46I.

Items 46A, 46B are original checks bearing a respective MICR line 48A, 48B. Items 46C, 46D are substitute checks (also sometimes referred to as “Image Replacement Documents” or IRDs), each bearing a respective MICR line 48C, 48D identical to the MICR line of the original check from which the substitute check was created. Items 46E-46I are image replacement document data sets (IRD data sets) each containing information, in digital electronic form, necessary to print a substitute check. The image replacement document data sets 46E-I are sometimes referred to as “electronic check images.” Each of items 46E-46I includes electronic data 48E-48I representing the information from the MICR line of the original paper check from which the electronic data set was prepared.

The clearing intermediary 22 then performs a data capture wherein the clearing intermediary obtains or “captures” an identifier from each item 46E-46I at step 52, typically the MICR line or data representing the MICR line, but any other identifier may be employed within the scope of the claimed invention. For each of the original checks 46A, 46B and the substitute checks 46C, 46D, the scanner 30, at step 52, generates a respective data set including a respective identifier, e.g., the information contained in the MICR line. At step 52, the communications link 34 receives the data sets 46E-I from one or more of the BOFDs 18A-18C, and transmits the data sets 46E-I to the processor 42. The processor then extracts the data 48E-I representing a MICR line from each of IRD data sets 46E-I.

If an identifier besides the MICR information is used, then optical character recognition or other suitable technologies may be employed to capture the identifier. Each identifier of items 46A-46I should be unique. If the identifier of any of items 46A-46I is identical to the identifier of another of items 46A-46I, or any other check, substitute check, or electronic check image, then an erroneous replication of a check has occurred, which may result in the account of the payor of the original check being debited erroneously.

The database 38 stores identifiers of items that have been processed by the clearing intermediary 22, and, optionally, other clearing intermediaries. At step 56, the processor 42 compares the identifier of one of the items 46A-46I received to the stored identifiers in the database 38 and searches for a match. In other words, the processor 42 checks the contents of the database 38 to determine whether an item having the same identifier has already been processed. If the MICR information for a particular item 46A- 461 is already in database 38 at step 56, e.g., if the routing/transit number, account number, and check number of one of the items 46A-46I are found in the database 38 at step 56, then the item is a replication of an earlier processed item.

Thus, for example, the system 28 captures the identifier, e.g., the routing/transit number, account number, and check number, from item 46A at step 52 via scanner 30, then compares the unique identifier 48A of item 46A to the contents of the database 38 at step 56, which may include searching the database 38 for the unique identifier of item 46A. At step 60, the processor 42 inquires whether the unique identifier of item 46A is in the database. If the unique identifier of item 46A is in the database 38, then the at least one processor 42 generates a notification signal 62 that is transmitted through the communications link 34 to notify the BOFD 18A that transmitted the item 46A, and the paying bank, i.e., one of 26A-D, that corresponds to the routing/transit number of the item 46A, at step 64. The notification signal may also be sent to a correspondent bank or another clearing intermediary. Within the scope of the claimed invention, a notification signal is transmitted to an entity when the notification signal is transmitted to an agent of the entity.

If the unique identifier of item 46A is not in the database 38, then the processor 42 adds the unique identifier of item 46A to the database 38 at step 68. The clearing intermediary 22 then transmits a check or substitute check for the item processed to the paying bank that corresponds to the routing/transit number of the item 46A at step 70.

The processor 42 completes all of steps 56, 60, and 64 or 68 for one of items 46A-I before performing the steps for the others of items 46A-I. In other words, the processor 42 completes steps 56, 60, and 64 or 68 for only one item before performing steps 56, 60, and 64 or 68 for another item. Accordingly, if a subsequently processed item has the same unique identifier as item 46A, the unique identifier of item 46A will be found in the database 38 during processing of the subsequent item at step 56.

For example, if item 46C is an erroneous replication of original check 46A, then items 46A and 46C will have identical identifiers. If item 46C is processed after item 46A, then the replication will be determined during processing of item 46C at step 60. Similarly, if item 461 is an erroneous replication of item 46H, then they will have identical identifiers. If the processor 42 completes steps 56, 60, and 68 for item 46H before 46I, then the identifier of item 46H will be a stored identifier in the database 38 when the processor 42 performs steps 56 and 60 for item 46I.

Alternatively, and within the scope of the claimed invention, the database 38 may be maintained by a third party other than the clearing intermediary 22. The clearing intermediary, or multiple clearing intermediaries, may transmit identifiers to the third party, which would then perform steps 56, 60, and 68, and notify the clearing intermediary 22 if the answer to the inquiry at step 60 is affirmative.

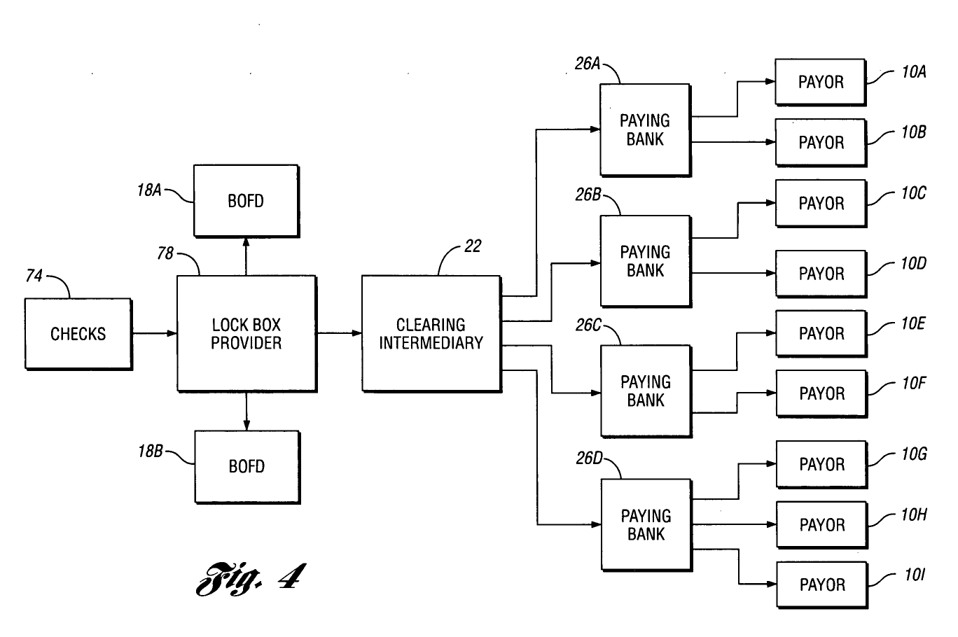

Referring to FIG. 4, wherein like reference numbers refer to like components from FIGS. 1-3, a second check clearing scenario is schematically depicted. Checks are often sent to “lockboxes” for bill payments, etc. Lockbox service providers can be banks or third party providers. In a lockbox scenario, checks may never physically be deposited at a bank, but information accumulated in the processing of those items is transmitted to banks and the payees. Some lockbox providers may be considered a “third party intermediary” within the scope of the claimed invention. Items processed by a lockbox service provider may also enter the clearing system and be processed by any of a number of different intermediaries. In the scenario of FIG. 4, a lockbox provider 78 receives checks 74 from multiple payors as understood by those skilled in the art and transmits checks, check images (electronic images) or substitute checks to clearing intermediary 22. The lockbox provider 78 transmits deposit data to Banks of First Deposit 18A,18B. Steps 52, 56, 60, and 64 or 68 may be advantageously performed by lockbox provider 78. Similarly, the system 28 may be advantageously used by lockbox provider 78.

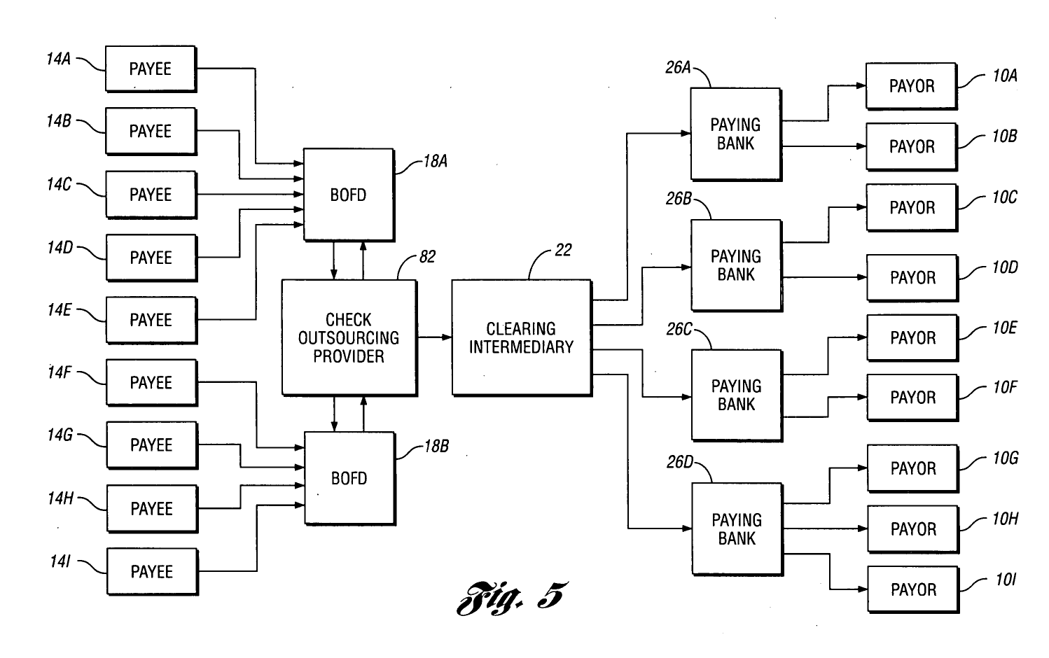

Referring to FIG. 5, wherein like reference numbers refer to like components from FIGS. 1-4, a third check clearing scenario is schematically depicted. Many banks do not have their own check operations, but have instead chosen to outsource their check operations to a third party processor 82. More specifically, BOFDs 18A, 18B receive checks from payees 14A-141. BOFDs 18A, 18B transmit the checks received from the payees to the third party processor 82, which then sends checks, substitute checks, and/or electronic check images to the clearing intermediary 22. The check outsourcing provider 82 transmits deposit data to the BOFDs 18A, 18B. This example demonstrates how an outsourcing provider, which processes items on behalf of multiple banks or other entities, may also be considered a clearing intermediary within the scope of the claimed invention and could advantageously employ system of FIG. 2 and the method of FIG. 3. A clearing intermediary may also include an outsourcing provider for paying banks within the scope of the claimed invention.

While the best modes for carrying out the invention have been described in detail, those familiar with the art to which this invention relates will recognize various alternative designs and embodiments for practicing the invention within the scope of the appended claims.

1. A system for detecting duplicate checks during check processing comprising:
at least one scanner sufficiently configured to scan original checks and substitute checks originating from a first plurality of entities and, for each of said original checks and substitute checks, generate a respective data set including a respective identifier including a respective routing/transit number, a respective account number, and a respective check number;
at least one electronic communication link in selective electronic communication with a second plurality of entities and sufficiently configured to receive image replacement document data sets in electronic form, each of said data sets containing information necessary to prepare a respective substitute check including a respective identifier including a routing/transit number, an account number, and a check number;
a storage medium storing a database of stored identifiers; and
at least one computer processor operatively connected to said at least one scanner and said at least one communication link to receive the data sets therefrom;
said at least one computer processor being sufficiently programmed and configured to (1) for each data set received from said at least one scanner and said at least one electronic communication link, determine whether the respective identifier is identical to one of the stored identifiers in the database; (2) store the respective identifier in the database if the respective identifier is not identical to one of the stored identifiers in the database; and (3) transmit a notification signal if the respective identifier is identical to one of the stored identifiers in the database.

2. The system of claim 1, wherein each of said identifiers includes data identifying a respective paying bank; wherein said at least one electronic communication link is in electronic communication with a plurality of paying banks; and wherein the system is configured to notify, via said at least one communications link, the paying bank identified in an identifier of one of said data sets that is identical to one of the stored identifiers.

3. The system of claim 1, wherein the system is configured to notify, via said at least one communications link, a bank of first deposit or a clearing intermediary when an identifier of one of said data sets is identical to one of the stored identifiers.

4. The system of claim 1, wherein said first or second plurality of entities includes a plurality of banks of first deposit.

5. The system of claim 1, wherein said first or second plurality of entities includes at least one lockbox provider.

6. The system of claim 1, wherein said first or second plurality of entities includes at least one clearing intermediary.

7. A method of detecting item replication during check processing, the method comprising:
providing a clearing intermediary;
receiving at said clearing intermediary a plurality of checks, substitute checks, and/or electronic check images from a plurality of entities;
for each of said plurality of checks, substitute checks, and electronic check images,
obtaining a respective identifier that includes a respective routing/transit number, a respective account number, and a respective check number;
comparing the respective identifier to stored identifiers in a database;
determining whether the respective identifier is identical to any of the stored identifiers in the database;
notifying a third party if the respective identifier is identical to any of the stored identifiers in the database; and
storing the respective identifier in the database if the respective identifier is not identical to any of the stored identifiers.

8. The method of claim 7, wherein said plurality of entities includes a plurality of banks of first deposit.

9. The method of claim 7, wherein said plurality of entities includes at least one lockbox provider.

10. The method of claim 7, wherein said plurality of entities includes at least one check outsourcing provider.

11. The method of claim 7, wherein said plurality of entities includes at least one clearing intermediary.
